(19) United States
(12) Patent Application Publication
(10) Pub. No.: US 2015/0363856 A1
(43) Pub. Date: Dec. 17, 2015

(54) PORTABLE WIRELESS INFORMATION UNIT FOR PROVIDING DATA TO AND RECEIVING DATA FROM MOBILE DEVICES

(71) Applicants: Derek Rinicella, Streetsboro, OH (US); Dean Rinicella, Aurora, OH (US)

(72) Inventors: Derek Rinicella, Streetsboro, OH (US); Dean Rinicella, Aurora, OH (US)

(21) Appl. No.: 14/738,625

(22) Filed: Jun. 12, 2015

Related U.S. Application Data
(60) Provisional application No. 62/011,185, filed on Jun. 12, 2014.

(51) Int. Cl. G06Q 30/06; H04W 4/00

(52) U.S. Cl. CPC G06Q 30/0623; H04W 4/008

(57) ABSTRACT

An information unit associated with assets in a building that can more effectively integrate with mobile wireless devices carried by users to provide information about product or assets being sold on a store shelf or stored in a warehouse. A housing enables self-contained capability for the information unit and enables autonomous operation and physical association with product or assets located throughout a store or warehouse. A short-range wireless module supports interaction with mobile devices (e.g., smartphones, tablets, and/or data enabled glasses) carried by customers and employees. A touch sensitive screen supports direct interaction by customers and employees, displaying information and receiving physical input. A product/asset information module provides data for display and/or announcement on the unit about associated products or assets. The product/asset information can include: product information, asset information, processing steps for handling assets, coupons, recipes, and remote information access via website URLs, location information.

### CROSS REFERENCE TO RELATED APPLICATIONS

This patent application claims the benefit under 35 U.S.C. §119(e) of U.S. Provisional Patent Application Ser. No. 62/011,185 filed on Jun. 12, 2014, entitled “PORTABLE WIRELESS INFORMATION UNIT FOR PROVIDING DATA TO AND RECEIVING DATA FROM MOBILE DEVICES,” which is hereby incorporated by reference in its entirety.

### FIELD OF THE INVENTION

The present embodiments are related to mobile devices and their use in the exchange or accessing of information. More particularly, the present embodiments are related to a self-contained, portable information unit that can be physically placed in association with product and/or assets in a facility for the purpose of providing information about the products and/or assets to mobile devices carried by users in the facility. Further embodiments relate to information devices capable of being controlled via mobile devices.

### BACKGROUND

Product, inventory and other assets are placed, stored and held in, or moved about within, large facilities such as stores and warehouses. Limited information is generally available in association with products. Information displays and coupon dispensers are sometimes placed next to products placed on store shelves so that customers can obtain information or discounts for the associated product, however, typically electronic information displays are not wireless, nor can they synchronize and communicate information with mobile devices carried by customers or enterprise employees. Portable devices are not typically provided in association with inventory stored in warehouses or storage rooms. Sometimes the lack of a strong cellular or Wi-Fi network signal in retail stores or warehouses prohibits data exchanges that would normally occur in the real world (office and home) from happening in more limiting environments. What is needed is a portable, wireless information unit that can more effectively interface with mobile devices and provide information about product or assets being sold or stored in addition to being configured to receive controlling commands from mobile devices.

### SUMMARY

Embodiments of a portable, wireless information unit (“information unit”) associated with assets in a building that can more effectively integrate with mobile devices carried by users to provide information about product or assets being sold on a store shelf or stored in a warehouse is disclosed herein.

It is a feature of the present invention to provide a portable, wireless information unit with housing that enables self-contained capability for the information unit and enables autonomous operation and physical association with product or assets located throughout a store or warehouse.

It is another feature to provide a short-range wireless module in association with the information unit that supports interaction with mobile devices (e.g., smartphones, tablets, and/or data enabled glasses) carried by customers and employees.

It is another feature to provide a touch sensitive screen in association with the information unit that supports direct interaction by customers and employees, displaying information and receiving physical input.

It is yet another feature to provide a product/asset information module in association with the information unit that provides data for display and/or announcement on the system about associated products or assets. The product/asset information module can utilizes the short-range wireless module to broadcast information to mobile devices carried by users near the information unit to provide product/asset information including at least one of product information, asset information, processing steps for handling assets, coupons, recipes, remote information access via website URLs, or location information.

It is another feature that a remote control module can also be associated with the information unit to allow users to interact with and control the information unit via their mobile device.

In yet another feature, at least one of WiFi or cellular data communications module can be included with the information unit to enable access to remote servers and data for use/display at the information unit when associated with product or assets.

It is a feature of the present embodiments to provide a self-contained, wireless, portable information unit (“Information unit”) adapted for autonomous operation and physical association with product or assets located throughout a store or warehouse is described. The unit can include a scanner, short-range wireless module for interaction with mobile devices, such as smartphones, tablets and data-enabled glasses used by customers and employees, touch sensitive screen for direct interaction by customers and employees, product information modules for displaying and/or announcing information about associated products or assets, and wireless broadcast capabilities for transmitting additional information to mobile devices (e.g., coupons, recipes, website URLs, location information, etc.). Advertising video rendered on the screen can be in the form of a media loop, periodically repeating information about an associated product. Instructional video can also be rendered on the screen in the form of tutorials or steps for handling assets with which the device is associated with during shipping or storage.

It is another feature of the present embodiments a system can be provided in association with the proximity unit to wirelessly transfer coupons and information automatically to mobile devices via short-range wireless communications that can be achieved s via the system's wireless field communication (WFC) module. The WFC can be provided in the form of Bluetooth technology, including low energy Bluetooth technology, Wi-Fi direct and NFC communications, depending on the range required for a given application. An application on a user's mobile device can be separately set up (e.g., user profile) to accept or deny information from the self-contained information device.

It is another feature of the present embodiments that the self-contained information unit is configured to interface with and receive commands from a mobile device, such as a smartphone, tablet or data enabled glasses, to control certain components of the information device. The components of the information unit that can be controlled via a hand held device can include relays, solenoids, servos, motors, actuators, proximity sensors, and LED drivers. For example, a customer can use their mobile device to turn the information unit on/off, adjust the volume, adjust the screen display, and navigate menus on the information device, etc. The information unit and mobile device can interface via an application installed on the mobile device that provides a user interface for controlling the information device.

It is yet another feature of the present embodiments that the system can also operate as a positioning system within a store environment for mobile devices roaming about the store environment. The information unit can operate like a beacon and its information can be utilizable by mobile devices to navigate a store using a map that can be rendered on a screen associated with the mobile devices. This feature would be useful in large shopping venues, such as malls, amusement parks and sports venues, as well as large warehouses.

A field service capability can also be provided within the self-contained information device. Information devices in the field generally required that local service representatives visit the store to service and update the devices. This need for representatives adds to the cost of use/ownership. It would be desirable for store employees/management to provide on-site maintenance and data update tasks for the information devices. The present system allows store employees and management to utilize a mobile tablet or smartphone to download data upgrades, then connect to each information unit and update information associated with an existing product or a new product that the information unit can become associated with.

It is another feature of the embodiments that the unit can also be utilized as an asset-tracking beacon. The device can be provided as a beacon with a shipment (e.g., goods on a pallet or in a cargo box) and a mobile device (e.g., smartphone, tablet or data-enabled glasses) can be used to find the location of a particular shipment based on signal strength of a wireless signal being emitted from the information unit (e.g., a signal strength meter displayed on the mobile device or a sound patters that intensifies and become rapid as signal strength increases).

It is yet another feature that the information unit can also be used to track equipment, such as hospital equipment, being used throughout a hospital facility. The system can track to location of its use, and a mobile device user can track the location of the system based on its signal.

It is yet another feature that patients and pets can be tracked using the wireless module associated with this system. For example, a patient wearing/associated with the device can roam about a controlled environment and notifications can be sent or alarms triggered if the patient roams outside of a controlled environment/zone. If the patient should fully escape the controlled environment, the wireless module acts as a beacon to enable staff with mobile devices to track the patient's locations or direction.

### SUMMARY OF THE DRAWINGS

FIG. 1 illustrates a high-level block diagram of a system including an information unit in accordance with the present embodiments.

FIG. 2 illustrates a flow diagram for remote control of an information unit via a mobile device to invoke alternative features.

FIG. 3 illustrates alternative views of the information unit in accordance with features of the present embodiments.

FIG. 4 illustrates photograph of an information unit in close proximity to and communication with a handheld device, in accordance with features of the present embodiments.

FIG. 5 illustrates a flow diagram for using an alternative system configuration in accordance with features of the present embodiments.

FIG. 6 illustrates a flow diagram for using an alternative system configuration in accordance with features of the present embodiments.

FIG. 7 illustrates a flow diagram for using an alternative system configuration in accordance with features of the present embodiments.

### DETAILED DESCRIPTION

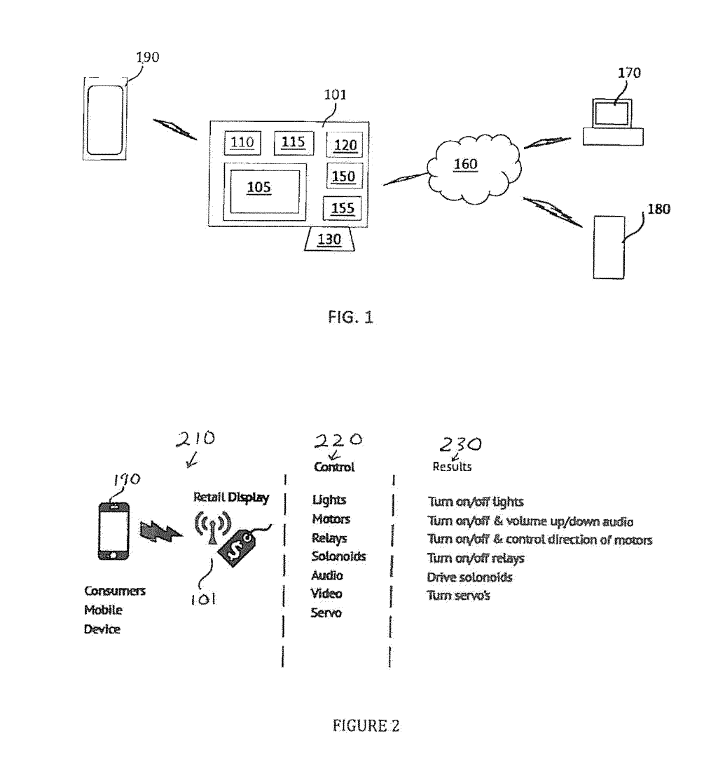

Referring to FIG. 1, the information unit 101 can be provided similar in form to a portable hand held device (e.g., a mounted tablet), and can provide presentations (e.g., Flash-based presentations) on a touch-sensitive display screen 105. The unit can also includes a feature programming module 110, memory 115 and a short-range wireless module 120. A general purpose of the system can be for its use as an “at shelf,” (e.g., shelf mounted) point of sale information system. It can be used as a video delivery system, a question and answer product selector system, a listening center (headphones, sound bars, docking stations, etc.), and can further include an optional bar code scanning system 130 or any combination of all the previous mentioned components or functions.

An android backer stored as programming in feature programming module 110 can be included in the unit to add the features of true tablet and smartphone functions such as “swype” touch screen control (i.e., where a user swipes their finger across the screen to get scrolling type movement), loading of apps onto the unit 101 which gives stores and their customers more control and features compared to a normal flash-based system. The short-range wireless module 120 can enable short-range wireless communications features. The unit can also include Wi-Fi or cellular communications module 150 enabling the unit to also connect to a network 160, whether it is a cell network or retailer network. By connecting to a network 160, the unit 101 can be checked remotely by a service client 170 to ensure it is working and playing the latest content, metrics can be sent from the unit 101 to a remote server 180 and the unit can be updated with content remotely. The information unit 101 can also include a remote control module 155 to allow a mobile device to interface with and control the information unit 101.

Close proximity wireless features enable unique features for the current embodiments and can be carried out by the short-range wireless module 120. This short-range wireless feature can enable a wireless connection between the unit 101 and a user's (customer or employee) mobile device 190 (smart phone, tablet and/or data-enabled glasses). In one embodiment, the user's mobile device 190 does not need to have a special app loaded thereon to communicate with the unit 101. This feature allows brands or retailers to give the consumer a “takeaway” that is dropped onto their mobile device 190 via their mobile device's browser once the device mobile 190 is connected to the short-range wireless signal that the unit can broadcast. Short-range wireless technology such as Bluetooth and RFID can support short-range communications. In particular, Bluetooth LE (low energy) can limit the distance wherein a user carried mobile device 190 can communicate with an information unit 101 provided in accordance with teachings of the present embodiments.

A remote control module 155 can also be associated with the information unit 101 to allow users to interact with and control the information unit 101 via their mobile device 190. The self-contained information unit 101 can be configured to interface with and receive commands from a mobile device 190 via the remote control module 155, which allows the mobile device 155 to control certain components of the information device 101. The components of the information unit 101 that can be controlled via a mobile device can are listed in the process shown in FIG. 2, and include relays, solenoids, servos, motors, actuators, proximity sensors, and LED drivers. A user can use their mobile device 190 to connect with, as shown in step 210 and turn the information unit 101 on/off, adjust the volume, adjust the screen display, and navigate menus on the information device 101, etc. The information unit 101 and mobile device can interface via an application installed on the mobile device 190 that provides a user interface for controlling the information device 101. Once connected, the mobile device and information device can control features as shown in Step 220, with result of interaction listed in Step 230.

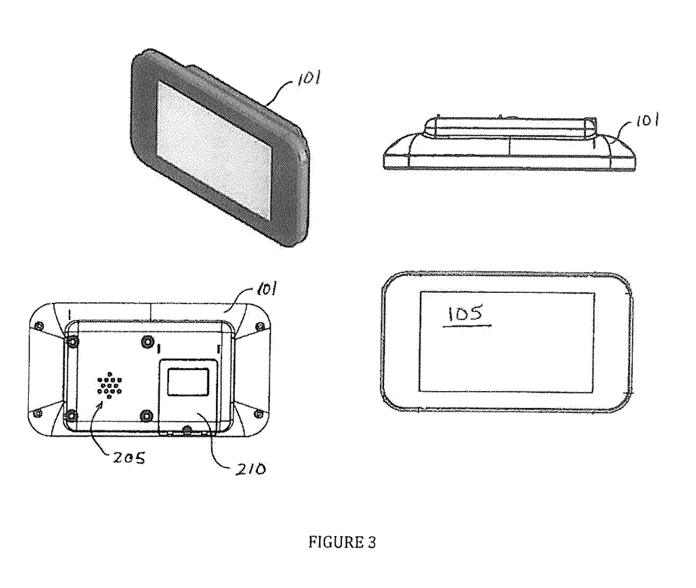

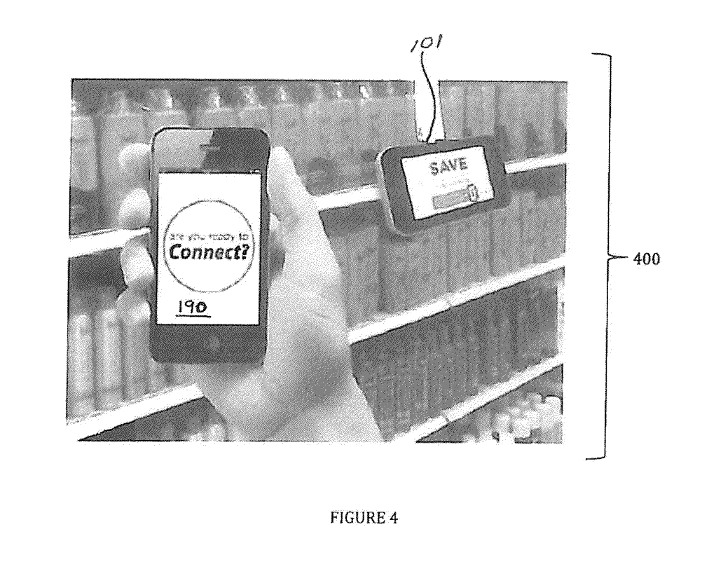

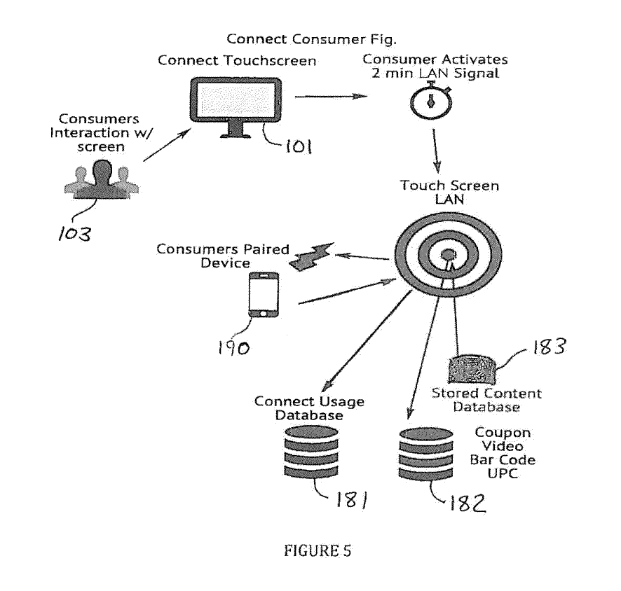

Referring to FIG. 3, alternative views of the information unit 101 in accordance with features of the present embodiments are shown. A speaker 205 and access panel 210 are shown located at the rear of the information unit's housing. The touch-sensitive screen 105 is also shown. Referring to FIG. 4, a photograph 400 of an information unit 101 mounted on a product shelf in a retail setting is shown with a mobile device 190 initiating communication at short range with the information unit 101.

Referring to FIG. 5, an exemplary method for use of the information device 101 is shown. A user 103 can initiate a wireless connection with the information unit 101 from their mobile device 190. This can be done by pressing a WFC (wireless field communications) button on their mobile device 190, where they can be instructed to use their mobile device 190 to find the information unit's 101 Wi-Fi signal (e.g., find “INFINITY”). It can also be done by touching the touch-sensitive display 105 on the information unit to initiate a signal (e.g., Bluetooth low energy beacon signal) for the mobile device 190 to use for connecting to the information unit 101 at short range. Furthermore, users can have their mobile devices self-discover available Wi-Fi networks or Bluetooth devices, thus simplifying the process of connecting. Another proven way to connect would be to go to SETTINGS on a mobile device, select WFC, search for WFC signals, find INFINITY, press on INFINITY to connect (generally, no password may be needed to connect to the wireless signal). Ideally, connection should take less than two minutes, whether directly via short-range wireless, or through a wireless LAN at the store supporting communication with information units located throughout the store. Once connected the consumer can be instructed to open their mobile device's Internet browser (e.g., Safari for iPhones, Google for most Android). When that is done the information unit 101 can display the “takeaway” on the mobile device 190 web browser. This “takeaway” can be a coupon with Bar Code that can be scanned by the retailer to be redeemed at checkout but can also include a variety of other things—i.e.—weblink to direct consumers to the retailers or brands website to redeem a rebate, get more consumer personal data, etc.—recipes based on what item is being purchased—shopping lists for recipe ideas—web links to instruction or installation videos—suggestion of items to compliment the item being purchased (e.g., food to go with wine or been selected, other items needed to complete a certain project, etc.). Furthermore, when information is retrieved, once the consumer opens their browser on their personal device they can then take a screen shot of that web page to save what they see on their device. Coupons and related information can be obtained from a coupon database 182. Supplemental content about a product (e.g., specification, recipes) can be obtained from a stored content database 183. A usage database 181 can track customer interaction, history and profile information.

The information unit 101 can show step by step instruction with “are you ready to continue prompts” with multiple screen levels to guide the consumer through the process of getting the takeaway. For example, the pages can display content as follows:

Page #1=Do you wish to receive the takeaway offer?

Page #2=Find the device's wireless signal using your device: open SETTINGS —search for short-range wireless signals (SSID) —Select applicable signal.

Page #3=What type of device are you using: IPHONE—IPAD—GOOGLE GLASSES—ANDROID —WINDOWS?

Page #4=Instruction based on device choice on what browser to open and what to do if takeaway is not seen when browser is first opened.

Page #5=Instruction on how to take a screen shot to save the takeaway based on what device a user has.

### Service App Outline

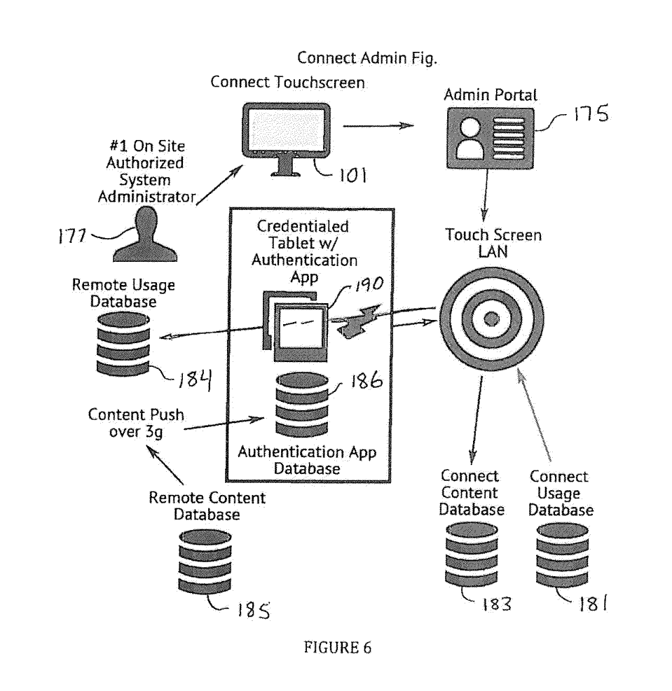

As shown in FIG. 6, an information unit can be accessed by authorized system administrators 177 located on-site. Service representatives 177 can utilize a Service App on their mobile device 190 to upgrade and maintain information units 101 in the field (e.g., mounted on shelves). The service App can be opened when the Rep is in close proximity (e.g., directly in front) of the information unit 101 within a store to start the authorized service communication between the unit and the rep. The representative can also use the touchscreen 105 on the information unit for administration and maintenance. So both the mobile device and touchscreen are accessible by the administrator 177 for maintenance, updating of content, etc. Access can be provided to an Administrative Portal 175 wherein updated data or maintenance data can be obtained/access. A service representative can be granted access if the representative is authorized. Authorization can be determined by accessing an authentication database 186. Representative 177 can gain access to content databases 184, usage databases, 181 and remote content databases 185. Remote content databases may not be accessible by the consumer and can be where representative 177 obtain updated programs and data for information units 101, or databases (e.g., 181/182/283) supporting the information units for a particular store with coupons, content and usage information. A remote usage database 184 can be accessed to store usage data obtained from the usage database 181 associated with the store. A remote usage database can compile information from store-related usage database for subsequent commercial uses useful to the retail industry (e.g., data mining, demographic targeting, etc.).

UPDATING CONTENT: The rep 177 can also receive updated content for an information unit 101 via an e-mail link that they can access and download the content onto their mobile device 190, which can be stored in a folder on the Service App. When the rep 177 is in front of the information unit 101 they can open the Service App, the information unit 101 can recognize the Service App and a screen can appear asking the rep 177 what they want to do, (e.g., Upload Content or Pull Metrics and Measures). The rep can then select Upload Content and the information unit 101 can automatically pull the data from the mobile device 190 and update the content of the marketing/information module associated with an information unit 101 and/or content database 182, as needed.

METRICS: Similar to the above, if the rep 177 chooses METRICS, the portable unit can push the latest data from the unit and/or usage database 181 to the Rep's mobile device 190. Once the rep 177 has a good cellular or WiFi signal, the data can be sent to a remote server 184 (e.g., corporate, contractor, or 3^{rd} party data Collection agency). The data can then be processed into charts and graphs to be sent to any interested party that may be paying for the data collection (e.g., data mining).

### Overview

The unit described in the embodiments herein is a concise, self-contained package to offer a unique system for the retail industry, and quite possibly for other industries that can leverage the capabilities of the disclosed system, which are further described below.
Information unit 101
   Programmable with service features provided from carried user device
   User interface (e.g., buttons, touch screen interface, or both)
Short-Range Wireless
   Consumer
      Connect to mobile devices
      Take-away—coupons, product info, instructions (how-to's, recipes)
   Service
      Update content using reps phone/tablet
      Pull metrics/push maintenance
Wi-Fi/3G Network (optional)
   In-store network and/or data plan required
   Antenna may be required for signal
Consumer Engagement
   Connect with consumers' mobile devices
   Take Away—coupons, product information and instructions
   Allows consumer control of unit
Push Content*
   Send “content” changes to displays for different times of the day
Pull Data and Metrics*
   Activation points, day part
Print to an “in store printer”-coupons or instruction information
Supports RF Technology
   Request help in an aisle
   Connect with iFinder Product Locator
Supports Barcode Scanner
   Product information and videos
Maintenance Check
   Receive “metrics” on usage and battery levels for in store displays
Bluetooth Enabled
   Pair with CE Devices

The Interactive display of the information unit 101 cab include a microprocessor based media computer that allows interaction with a shopper. The system can be either AC powered or battery powered. The display can be placed at a convenient location on a shelf, a counter top, or any location that would allow a shopper to make selections for product information and obtain coupons, receipts, or other desired data through a wireless connection to the shopper's mobile device (e.g., smartphone, tablet device and/or data-enabled glasses). The information unit 101 can also be configured so as to allow a shopper to interact with and control the display via their mobile device 190.

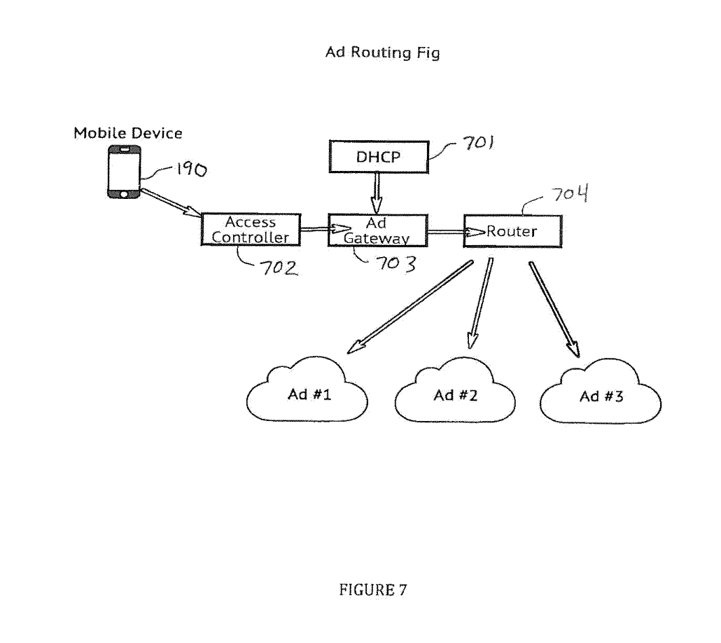

How the system works remotely: Referring to FIG. 7, in one embodiment, the shopper can connect with an information unit 101, or make product information selections on the display of the information unit 101. Mobile access can be managed by an access controller 702 associated with the information unit 101 by means previously described. On the information unit 101, selection scan be made by either touching the front-sided buttons on the side of the display or by touching the touchscreen (if so equipped). When the desired information is displayed, the customer can request a copy of the information through a wireless frequency connection to their personal mobile device (e.g., smartphone, tablet and/or data-enabled glasses). The shopper can use their device to look for the interactive display, accept a connection to the interactive display, then save the displayed information to their mobile device. Information can be obtained in the form of advertising via an ad gateway 703. The ad gateway can obtain information remotely via support of a data network infrastructure, such as DHCP 701 and router 704. Data contained remotely can include advertisings from sources represented by Clouds in the drawing. An information unit 101 can terminate a connection shortly after the information is transferred. The range of the wireless connection can be limited in distance so as not to interfere with other wireless networks in the area, and so that transfer of data can be from the interactive display to the intended shopper.

In an alternate embodiment, a user can download and install an application onto their mobile device that allows the device to interact with and control various aspects of the information unit 101 instead of physically touching buttons on the unit or the display screen itself. A system that provides for control of the display via a portable electronic device can include a low energy Bluetooth device that creates a personal area network comprised of various components that, together, create a wireless communication matrix to control mechanical components of the information unit 101. Such mechanical components can include relays, solenoids, servos, proximity sensors, and LED drivers. Allowing a shopper to control these types of components via their mobile device provides the shopper with the ability to turn the unit on/off, adjust the volume, adjust the screen display, navigate menus on the information unit 101, etc.

In another alternate embodiment, the information unit 101 can be operably connected to a micro-controller and a strip of individually controllable light emitting diodes (LEDs). Upon receiving a signal from the information unit 101, the micro controller can activate a particular LED, wherein each LED can be associated with a specific product being held by a peg hook. Optical cable can connect each LED to the peg hook such that when the LED is activated, the light is transmitted via the optical cable so as to illuminate a tag associated with the peg hook and provide visual reference to a user of where a particular product is located. For example, when a user selects a certain product to be displayed on the information unit 101, the LED light associated with that product can be turned on and light from the LED can be conveyed via an optical cable such that a tag at the end of the peg hook is illuminated, allowing the user to easily see where in a display the product is located.

How the system works for application programming and metrics: The display can contain applications (Apps) specific for the functions required to display content, information gathering, information usage, and software updatability. Advanced controls can be protected by username and password to allow updates and metrics to be obtained and or programmed by specific approved “users” or “representatives”. Data associated with usernames and passwords can be managed in the authentication database 186. A wired USB port, or a wireless communication port can communicate data.

How the system works to locate assets: When associated with assets in a warehouse of other facilities, a combination of short range and longer range wireless signals can be used to hone in on the information unit 101. For example, the information unit 101 can be attached to a pallet of product in a warehouse. A Wi-Fi connection can be used to hone in on the asset's general location. Once in the general location, the short range wireless module (e.g., Bluetooth LE) can be used as a beacon to hone in on the information unit 101 and the shipment. If the shipment requires special handling, a tutorial can be retrieved from the information unit 101, or can be viewed directly on the display associated with the portable system. The tutorial can tell a user how to handle, move, deploy, or use the shipped item (e.g., it can be equipment or hardware).

The device could also be attached in association with a live asset (e.g., person, pet) to find the live asset via wireless beaconing technology.

1. An information unit comprising:
a housing for a information unit adapted for mounting to assets to enable autonomous operation and physical association with assets located throughout an operating area;
a short-range wireless module for interaction with mobile devices;
a touch-sensitive display screen for displaying information and receiving physical input; and
a asset information module for displaying and/or announcing information about associated assets, wherein the asset information module utilizes the short-range wireless module to broadcast information to mobile devices carried by users near the information unit provides asset information including at least one of: product information, asset information, asset identification, processing steps for handling assets, coupons, recipes, remote information access via website URLs, location information.

2. The information unit of claim 1, further comprising at least one of WiFi or cellular data communications module to enable access to remote servers and data for use/display at the information unit when associated with product or assets.

3. The information unit of claim 1, wherein the short range wireless communication module further comprising at least one of NFC or Bluetooth LE data communications module to enable communication between the information unit and mobile devices.

4. The information unit of claim 1, wherein the controlling commands control components of the information unit.

5. The information unit of claim 3, wherein the components of the information unit comprise relays, solenoids, servos, motors, actuators, proximity sensors, or LED drivers.

6. The information unit of claim 1, further comprising a remote control module configured to interface with and receive controlling commands from the mobile devices

7. The information unit of claim 1, wherein an asset is at least one of: a product on a store shelf, inventory in a warehouse, a person.

8. An information unit comprising:
a housing for a information unit adapted for mounting to assets in a retail establishment or warehouse to enable autonomous operation and physical association with assets located throughout the retail establishment or warehouse;
a short-range wireless module for interaction with mobile devices carried by customers and employees;
a touch-sensitive display screen for displaying information and receiving physical input; and
a asset information module for displaying and/or announcing information about associated assets, wherein the asset information module utilizes the short-range wireless module to broadcast information to mobile devices carried by users near the information unit provides asset information including at least one of: product information, asset information, asset identification, processing steps for handling assets, coupons, recipes, remote information access via website URLs, location information.

9. The information unit of claim 8, further comprising a remote control module configured to interface with and receive controlling commands from the mobile devices.

10. The information unit of claim 8, further comprising at least one of WiFi or cellular data communications module to enable access to remote servers and data for use/display at the information unit when associated with product or assets.

11. The information unit of claim 8, wherein the controlling commands control components of the information unit.

12. The information unit of claim 8, wherein controllable components of the information unit comprise relays, solenoids, servos, motors, actuators, proximity sensors, or LED drivers.

13. The information unit of claim 8, wherein the short range wireless communication module further comprising at least one of NFC or Bluetooth LE data communications module to enable communication between the information unit and mobile devices.

14. A method for accessing information in a retail venue from an information unit, comprising:
providing an information unit mounted to a shelf in association with product located in a retail venue, said information unit including a housing for a information unit adapted for mounting to assets in a retail establishment or warehouse to enable autonomous operation and physical association with assets located throughout the retail establishment or warehouse, a short-range wireless module for interaction with mobile devices carried by customers and employees, a touch-sensitive display screen for displaying information and receiving physical input; and a asset information module for displaying and/or announcing information about associated assets, wherein the asset information module utilizes the short-range wireless module to broadcast information to mobile devices carried by users near the information unit provides asset information including at least one of: product information, asset information, asset identification, processing steps for handling assets, coupons, recipes, remote information access via website URLs, location information;
enabling customers to access product information and coupons direction from the information unit and wirelessly from a mobile device; and
providing product information and coupons to customers.

15. The information unit of claim 14, further comprising providing a mobile device with access to a remote control module configured to interface with and receive controlling commands from an authorized mobile device.

16. The information unit of claim 14, further comprising at least one of WiFi or cellular data communications module to enable access to remote servers and data for use/display at the information unit when associated with product or assets.

17. The information unit of claim 14, wherein the controlling commands control components of the information unit.

18. The information unit of claim 14, wherein controllable components of the information unit comprise relays, solenoids, servos, motors, actuators, proximity sensors, or LED drivers.

19. The information unit of claim 14, wherein the short range wireless communication module further comprising at least one of NFC or Bluetooth LE data communications module to enable communication between the information unit and mobile devices.

20. The information unit of claim 15, the remote control module enables a representative to provide controlling commands from an authorized mobile device to provide maintenance to and access data from the information unit.
